(19) United States
(12) Patent Application Publication
(10) Pub. No.: US 2020/0293041 A1
(43) Pub. Date: Sep. 17, 2020

(54) METHOD AND SYSTEM FOR EXECUTING A COMPOSITE BEHAVIOR POLICY FOR AN AUTONOMOUS VEHICLE

(71) Applicant: GM GLOBAL TECHNOLOGY OPERATIONS LLC, Detroit, MI (US)

(72) Inventor: Praveen Palanisamy, Sterling Heights, MI (US)

(21) Appl. No.: 16/354,522

(22) Filed: Mar. 15, 2019

(51) Int. Cl. G05D 1/00; G06N 3/08; G06N 3/04

(52) U.S. Cl. CPC G05D 1/0088; G05D 1/0276; G06N 3/0454; G06N 3/08

(57) ABSTRACT

A system and method for determining a vehicle action to be carried out by an autonomous vehicle based on a composite behavior policy. The method includes the steps of: obtaining a behavior query that indicates which of a plurality of constituent behavior policies are to be used to execute the composite behavior policy, wherein each of the constituent behavior policies maps a vehicle state to one or more vehicle actions; determining an observed vehicle state based on onboard vehicle sensor data, wherein the onboard vehicle sensor data is obtained from one or more onboard vehicle sensors of the vehicle; selecting a vehicle action based on the composite behavior policy; and carrying out the selected vehicle action at the vehicle.

### TECHNICAL FIELD

The present disclosure relates to autonomous vehicle systems, including those that carry out autonomous functionality according to a behavior policy.

### BACKGROUND

Vehicles include various electronic control units (ECUs) that carry out various tasks for the vehicle. Many vehicles now include various sensors to sense information concerning the vehicle's operation and/or the nearby or surrounding environment. Also, some vehicle users may desire to have autonomous functionality be carried out according to a style or a set of attributes.

Thus, it may be desirable to provide a system and/or method for determining a vehicle action based on two or more constituent behavior policies.

### SUMMARY

According to one aspect, there is provided a method of determining a vehicle action to be carried out by a vehicle based on a composite behavior policy. The method includes the steps of: obtaining a behavior query that indicates a plurality of constituent behavior policies to be used to execute the composite behavior policy, wherein each of the constituent behavior policies maps a vehicle state to one or more vehicle actions; determining an observed vehicle state based on onboard vehicle sensor data, wherein the onboard vehicle sensor data is obtained from one or more onboard vehicle sensors of the vehicle; selecting a vehicle action based on the composite behavior policy; and carrying out the selected vehicle action at the vehicle.

According to various embodiments, the method may further include any one of the following features or any technically-feasible combination of some or all of these features:
the selecting step includes carrying out a composite behavior policy execution process that blends, merges, or otherwise combines each of the plurality of constituent behavior policies so that, when the composite behavior policy is executed, autonomous vehicle (AV) behavior of the vehicle resembles a combined style or character of the constituent behavior policies;
the composite behavior policy execution process and the carrying out step are carried out using an autonomous vehicle (AV) controller of the vehicle;
the composite behavior policy execution process includes compressing or encoding the observed vehicle state into a low-dimension representation for each of the plurality of constituent behavior policies;
the compressing or encoding step includes generating a low-dimensional embedding using a deep autoencoder for each of the plurality of constituent behavior policies;
the composite behavior policy execution process includes regularizing or constraining each of the low-dimensional embeddings according to a loss function;
a trained encoding distribution for each of the plurality of constituent behavior policies is obtained based on the regularizing or constraining step;
each low-dimensional embedding is associated with a feature space Z₁ to Z_{N}, and wherein the composite behavior policy execution process includes determining a constrained embedding space based on the feature spaces Z₁ to Z_{N} of the low-dimensional embeddings;
the composite behavior policy execution process includes determining a combined embedding stochastic function based on the low-dimensional embeddings;
the composite behavior policy execution process includes determining a distribution of vehicle actions based on the combined embedding stochastic function and a composite policy function, and wherein the composite policy function is generated based on the constituent behavior policies;
the selected vehicle action is sampled from the distribution of vehicle actions;
the behavior query is generated based on vehicle user input received from a handheld wireless device;
the behavior query is automatically generated without vehicle user input;
each of the constituent behavior policies are defined by behavior policy parameters that are used in a first neural network that maps the observed vehicle state to a distribution of vehicle actions;
the first neural network that maps the observed vehicle state to the distribution of vehicle actions is a part of a policy layer, and wherein the behavior policy parameters of each of the constituent behavior policies are used in a second neural network of a value layer that provides a feedback value based on the selected vehicle action and the observed vehicle state; and/or
the composite behavior policy is executed at the vehicle using a deep reinforcement learning (DRL) actor-critic model that includes a value layer and a policy layer, wherein the value layer of the composite behavior policy is generated based on the value layer of each of the plurality of constituent behavior policies, and wherein the policy layer of the composite behavior policy is generated based on the policy layer of each of the plurality of constituent behavior policies.

According to another aspect, there is provided a method of determining a vehicle action to be carried out by a vehicle based on a composite behavior policy. The method includes the steps of: obtaining a behavior query that indicates a plurality of constituent behavior policies to be used to execute the composite behavior policy, wherein each of the constituent behavior policies maps a vehicle state to one or more vehicle actions; determining an observed vehicle state based on onboard vehicle sensor data, wherein the onboard vehicle sensor data is obtained from one or more onboard vehicle sensors of the vehicle; selecting a vehicle action based on the plurality of constituent behavior policies by carrying out a composite behavior policy execution process, wherein the composite behavior policy execution process includes: (i) determining a low-dimensional embedding for each of the constituent behavior policies

P040557-US-NP based on the observed vehicle state; (ii) determining a trained encoding distribution for each of the plurality of constituent behavior policies based on the low-dimensional embeddings; (iii) combining the trained encoding distributions according to the behavior query so as to obtain a distribution of vehicle actions; and (iv) sampling a vehicle action from the distribution of vehicle actions to obtain a selected vehicle action; and carrying out the selected vehicle action at the vehicle.

According to various embodiments, the method may further include any one of the following features or any technically-feasible combination of some or all of these features:
the composite behavior policy execution process is carried out using composite behavior policy parameters, and wherein the composite behavior policy parameters are improved or learned based on carrying out a plurality of iterations of the composite behavior policy execution process and receiving feedback from a value function as a result of or during each of the plurality of iterations of the composite behavior policy execution process;
the value function is a part of a value layer, and wherein the composite behavior policy execution process includes executing a policy layer to select the vehicle action and the value layer to provide feedback as to the advantage of the selected vehicle action in view of the observed vehicle state; and/or
the policy layer and the value layer of the composite behavior policy execution process are carried by an autonomous vehicle (AV) controller of the vehicle.

### BRIEF DESCRIPTION OF THE DRAWINGS

One or more embodiments of the disclosure will hereinafter be described in conjunction with the appended drawings, wherein like designations denote like elements, and wherein:

FIG. 1 is a block diagram depicting an embodiment of a communications system that is capable of utilizing the method disclosed herein;

FIG. 2 is a block diagram depicting an exemplary model that can be used for a behavior policy that is executed by an autonomous vehicle;

FIG. 3 is a block diagram depicting an embodiment of a composite behavior policy execution system that is used to carry out a composite behavior policy execution process; and

FIG. 4 is a flowchart depicting an embodiment of a method of generating a composite behavior policy set for an autonomous vehicle.

### DETAILED DESCRIPTION OF THE ILLUSTRATED EMBODIMENT(S)

The system and method below enable a user of an autonomous vehicle to select one or more constituent behavior policies (similar to predefined driving profiles or driving styles) that are combined to form a customized composite behavior policy. The composite behavior policy, in turn, may be executed by the autonomous vehicle so that the vehicle carries out certain vehicle actions based on observed vehicle states (e.g., sensor data). The system is capable of carrying out (and the method includes) a composite behavior policy execution process, which is a process that blends, merges, or otherwise combines the plurality of constituent behavior policies selected by the user into a composite behavior policy, which can then be used for carrying out autonomous vehicle functionality.

Various constituent behavior policies can be predefined (or pre-generated) and stored at the vehicle or at a remote server. According to one embodiment, a vehicle user can provide vehicle user input to select a plurality of constituent behavior policies that are to be provided as a part of a behavior query as input into a composite behavior policy execution process that is executed by the vehicle as a part of carrying out autonomous vehicle (AV) functionality. In general, the behavior query informs the composite behavior policy execution process of the constituent behavior policies that are to be combined and used in determining a vehicle action to be carried out by the vehicle. The behavior query may directly inform the composite behavior policy execution process, such as by selecting one or more predefined constituent behavior policies, or the behavior query may indirectly inform that process, such as by providing general behavioral information or preferences from the user which, in turn, is used by the present method (e.g., a learning method) to generate a composite behavior policy based on the constituent behavior policies. In one embodiment, the vehicle user input can be provided via a handheld wireless device (HWD) (e.g., a smartphone, tablet, wearable device) and/or one or more vehicle-user interfaces installed on the vehicle (e.g., a touchscreen of an infotainment unit). In another embodiment, the behavior query can be automatically-generated, which includes programmatically selecting a plurality of constituent behavior policies to use in forming the composite behavior policy. The composite behavior policy execution process includes obtaining an observed vehicle state, and then blending, merging, or otherwise combining the constituent behavior policies according to a composite behavior policy so as to determine a vehicle action or a distribution of vehicle actions, one of which is then carried out by the vehicle. In one embodiment, the composite behavior policy execution process is carried out using an actor-critic deep reinforcement learning (DRL) technique, which includes implementing a policy layer that determines a vehicle action (or distribution of vehicle actions) based on the observed vehicle state and a value layer that determines feedback (e.g., a value or reward, or distribution of values or rewards) based on the observed vehicle state and the vehicle action that was carried out.

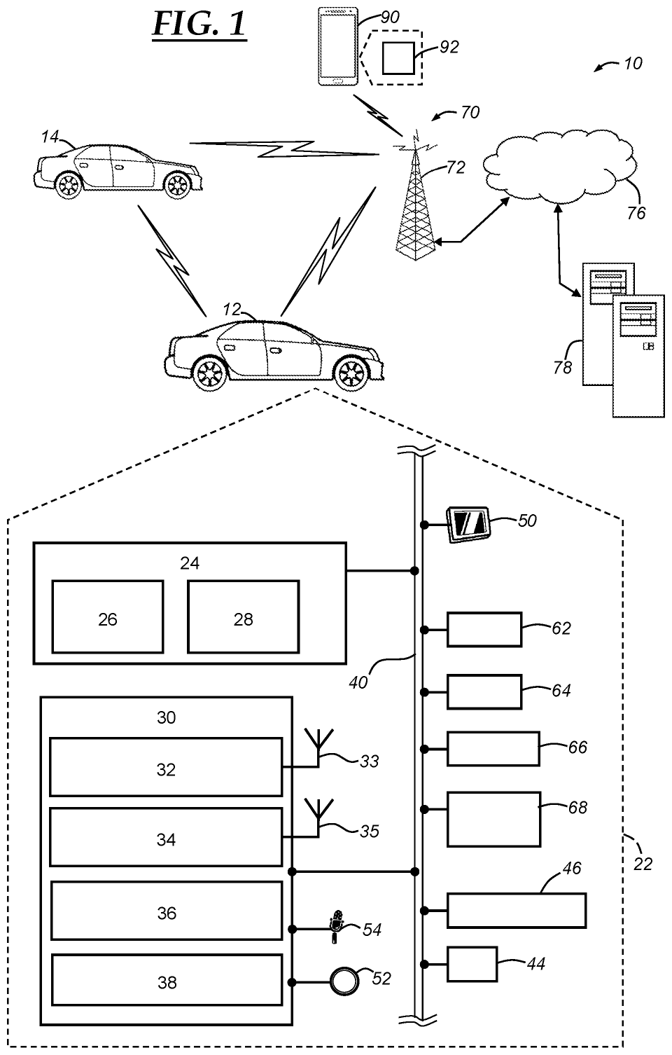

FIG. 1 illustrates an operating environment that comprises a communications system 10 and that can be used to implement the method disclosed herein. Communications system 10 generally includes autonomous vehicles 12, 14, one or more wireless carrier systems 70, a land communications network 76, remote servers 78, and a handheld wireless device (HWD) 90. As used herein, the terms “autonomous vehicle” or “AV” broadly mean any vehicle capable of automatically performing a driving-related action or function, without a driver request, and includes actions falling within levels 1-5 of the Society of Automotive Engineers (SAE) International classification system. A “low-level autonomous vehicle” is a level 1-3 vehicle, and a “high-level autonomous vehicle” is a level 4 or 5 vehicle. It should be understood that the disclosed method can be used with any number of different systems and is not specifically limited to the operating environment shown here. Thus, the following paragraphs simply provide a brief overview of one such communications system 10; however, other systems not shown here could employ the disclosed method as well.

The system 10 may include one or more autonomous vehicles 12, 14, each of which is equipped with the requisite hardware and software needed to gather, process, and exchange data with other components of system 10. Although the vehicle 12 is described in detail below, the description below also applies to the vehicle 14, which can include any of the components, modules, systems, etc. of the vehicle 12 unless otherwise noted or implied. According to a non-limiting example, vehicle 12 is an autonomous vehicle (e.g., a fully autonomous vehicle, a semi-autonomous vehicle) and includes vehicle electronics 22, which include an autonomous vehicle (AV) control unit 24, a wireless communications device 30, a communications bus 40, a body control module (BCM) 44, a global navigation satellite system (GNSS) receiver 46, vehicle-user interfaces 50-54, and onboard vehicle sensors 62-68, as well as any other suitable combination of systems, modules, devices, components, hardware, software, etc. that are needed to carry out autonomous or semi-autonomous driving functionality. The various components of the vehicle electronics 22 may be connected by the vehicle communication network or communications bus 40 (e.g., a wired vehicle communications bus, a wireless vehicle communications network, or some other suitable communications network).

Skilled artisans will appreciate that the schematic block diagram of the vehicle electronics 22 is simply meant to illustrate some of the more relevant hardware components used with the present method and it is not meant to be an exact or exhaustive representation of the vehicle hardware that would typically be found on such a vehicle. Furthermore, the structure or architecture of the vehicle electronics 22 may vary substantially from that illustrated in FIG. 1. Thus, because of the countless number of potential arrangements and for the sake of brevity and clarity, the vehicle electronics 22 is described in conjunction with the illustrated embodiment of FIG. 1, but it should be appreciated that the present system and method are not limited to such.

Vehicle 12 is depicted in the illustrated embodiment as a sports utility vehicle (SUV), but it should be appreciated that any other vehicle including passenger cars, motorcycles, trucks, recreational vehicles (RVs), unmanned aerial vehicles (UAVs), passenger aircrafts, other aircrafts, boats, other marine vehicles, etc., can also be used. As mentioned above, portions of the vehicle electronics 22 are shown generally in FIG. 1 and include an autonomous vehicle (AV) control unit 24, a wireless communications device 30, a communications bus 40, a body control module (BCM) 44, a global navigation satellite system (GNSS) receiver 46, vehicle-user interfaces 50-54, and onboard vehicle sensors 62-68. Some or all of the different vehicle electronics may be connected for communication with each other via one or more communication busses, such as communications bus 40. The communications bus 40 provides the vehicle electronics with network connections using one or more network protocols and can use a serial data communication architecture. Examples of suitable network connections include a controller area network (CAN), a media oriented system transfer (MOST), a local interconnection network (LIN), a local area network (LAN), and other appropriate connections such as Ethernet or others that conform with known ISO, SAE, and IEEE standards and specifications, to name but a few.

Although FIG. 1 depicts some exemplary electronic vehicle devices, the vehicle 12 can also include other electronic vehicle devices in the form of electronic hardware components that are located throughout the vehicle and, which may receive input from one or more sensors and use the sensed input to perform diagnostic, monitoring, control, reporting, and/or other functions. An “electronic vehicle device” is a device, module, component, unit, or other part of the vehicle electronics 22. Each of the electronic vehicle devices (e.g., AV control unit 24, the wireless communications device 30, BCM 44, GNSS receiver 46, vehicle-user interfaces 50-54, sensors 62-68) can be connected by communications bus 40 to other electronic vehicle devices of the vehicle electronics 22. Moreover, each of the electronic vehicle devices can include and/or be communicatively coupled to suitable hardware that enables intra-vehicle communications to be carried out over the communications bus 40; such hardware can include, for example, bus interface connectors and/or modems. Also, any one or more of the electronic vehicle devices can be a stand-alone module or incorporated into another module or device, and any one or more of the devices can include their own processor and/or memory, or may share a processor and/or memory with other devices. As is appreciated by those skilled in the art, the above-mentioned electronic vehicle devices are only examples of some of the devices or modules that may be used in vehicle 12, as numerous others are also possible.

The autonomous vehicle (AV) control unit 24 is a controller that helps manage or control autonomous vehicle operations, and that can be used to perform AV logic (which can be embodied in computer instructions) for carrying out the AV functionality. The AV control unit 24 includes a processor 26 and memory 28, which can include any of those types of processor or memory discussed below. The AV control unit 24 can be a separate and/or dedicated module that performs AV operations, or may be integrated with one or more other electronic vehicle devices of the vehicle electronics 22. The AV control unit 24 is connected to the communications bus 40 and can receive information from one or more onboard vehicle sensors or other electronic vehicle devices, such as the BCM 44 or the GNSS receiver 46. In one embodiment, the vehicle is a high-level autonomous vehicle. And, in other embodiments, the vehicle may be a low-level autonomous vehicle.

The AV control unit 24 may be a single module or unit, or a combination of modules or units. For instance, AV control unit 24 may include the following sub-modules (whether they be hardware, software or both): a perception sub-module, a localization sub-module, and/or a navigation sub-module. The particular arrangement, configuration, and/or architecture of the AV control unit 24 is not important, so long as the module helps enable the vehicle to carry out autonomous and/or semi-autonomous driving functions (or the “AV functionality”). The AV control unit 24 can be indirectly or directly connected to vehicle sensors 62-68, as well as any combination of the other electronic vehicle devices 30, 44, 46 (e.g., via communications bus 40). Moreover, as will be discussed more below, the AV control unit 24 can carry out AV functionality in accordance with a behavior policy, including a composite behavior policy. In some embodiments, the AV control unit 24 carries out a composite behavior policy execution process.

Wireless communications device 30 provides the vehicle with short range and/or long range wireless communication capabilities so that the vehicle can communicate and exchange data with other devices or systems that are not a part of the vehicle electronics 22, such as the remote servers 78 and/or other nearby vehicles (e.g., vehicle 14). In the illustrated embodiment, the wireless communications device 30 includes a short-range wireless communications (SRWC) circuit 32, a cellular chipset 34, a processor 36, and memory 38. The SRWC circuit 32 enables short-range wireless communications with any number of nearby devices (e.g., Bluetooth™, other IEEE 802.15 communications, Wi-Fi™, other IEEE 802.11 communications, vehicle-to-vehicle (V2V) communications, vehicle-to-infrastructure (V2I) communications). The cellular chipset 34 enables cellular wireless communications, such as those used with the wireless carrier system 70. The wireless communications device 30 also includes antennas 33 and 35 that can be used to transmit and receive these wireless communications. Although the SRWC circuit 32 and the cellular chipset 34 are illustrated as being a part of a single device, in other embodiments, the SRWC circuit 32 and the cellular chipset 34 can be a part of different modules—for example, the SRWC circuit 32 can be a part of an infotainment unit and the cellular chipset 34 can be a part of a telematics unit that is separate from the infotainment unit.

Body control module (BCM) 44 can be used to control various electronic vehicle devices or components of the vehicle, as well as obtain information concerning the electronic vehicle devices, including their present state or status, which can be in the form of or based on onboard vehicle sensor data and that can be used as or make up a part of an observed vehicle state. In one embodiment, the BCM 44 can receive onboard vehicle sensor data from onboard vehicle sensors 62-68, as well as other vehicle sensors not explicitly discussed herein. The BCM 44 can send the onboard vehicle sensor data to one or more other electronic vehicle devices, such as AV control unit 24 and/or wireless communications device 30. In one embodiment, the BCM 44 may include a processor and memory accessible by the processor.

Global navigation satellite system (GNSS) receiver 46 receives radio signals from a plurality of GNSS satellites. The GNSS receiver 46 can be configured to comply with and/or operate according to particular regulations or laws of a given region (e.g., country). The GNSS receiver 46 can be configured for use with various GNSS implementations, including global positioning system (GPS) for the United States, BeiDou Navigation Satellite System (BDS) for China, Global Navigation Satellite System (GLONASS) for Russia, Galileo for the European Union, and various other navigation satellite systems. The GNSS receiver 46 can include at least one processor and memory, including a non-transitory computer readable memory storing instructions (software) that are accessible by the processor for carrying out the processing performed by the GNSS receiver 46. The GNSS receiver 46 may be used to provide navigation and other position-related services to the vehicle operator. The navigation services can be provided using a dedicated in-vehicle navigation module (which can be part of GNSS receiver 46 and/or incorporated as a part of wireless communications device 30 or other part of the vehicle electronics 22), or some or all navigation services can be done via the wireless communications device 30 (or other telematics-enabled device) installed in the vehicle, wherein the position information is sent to a remote location for purposes of providing the vehicle with navigation maps, map annotations (points of interest, restaurants, etc.), route calculations, and the like. The GNSS receiver 46 can obtain location information, which can be used as a part of the observed vehicle state. This location information and/or map information can be passed along to the AV control unit 24 and can form part of the observed vehicle state.

Sensors 62-68 are onboard vehicle sensors that can capture or sense information (referred to herein as “onboard vehicle sensor data”), which can then be sent to one or more other electronic vehicle devices. The onboard vehicle sensor data can be used as a part of the observed vehicle state, which can be used by the AV control unit 24 as input into a behavior policy that then determines a vehicle action as an output. The observed vehicle state is a collection of data pertaining to the vehicle, and can include onboard vehicle sensor data, external vehicle sensor data (discussed below), data concerning the road on which the vehicle is travelling or that is nearby the vehicle (e.g., road geometry, traffic data, traffic signal information), data concerning the environment surrounding or nearby the vehicle (e.g., regional weather data, outside ambient temperature), edge or fog layer sensor data or information (i.e., sensor data obtained from one or more edge or fog sensors, such as those that are integrated into traffic signals or otherwise provided along the road), etc. In one embodiment, the onboard vehicle sensor data includes one or more CAN (or communications bus) frames. The onboard vehicle sensor data obtained by the onboard vehicle sensors 62-68 can be associated with a time indicator (e.g., timestamp), as well as other metadata or information. The onboard vehicle sensor data can be obtained by the onboard vehicle sensors 62-68 in a raw format, and may be processed by the sensor, such as for purposes of compression, filtering, and/or other formatting, for example. Moreover, the onboard vehicle sensor data (in its raw or formatted form), can be sent to one or more other electronic vehicle devices via communications bus 40, such as to the AV control unit 24, and/or to the wireless communications device 30. In at least one embodiment, the wireless communications device 30 can package the onboard vehicle sensor data for wireless transmission and send the onboard vehicle sensor data to other systems or devices, such as the remote servers 78. In addition to the onboard vehicle sensor data, the vehicle 12 can receive vehicle sensor data of another vehicle (e.g., vehicle 14) via V2V communications—this data from the other, nearby vehicle is referred to as external vehicle state information and the sensor data from this other vehicle is referred to more specifically as external vehicle sensor data. This external vehicle sensor data can be provided as a part of an observed vehicle state of the other, nearby vehicle 14, for example. This external vehicle state information can then be used as a part of the observed vehicle state for the vehicle 12 in carrying out AV functionality.

Lidar unit 62 is an electronic vehicle device of the vehicle electronics 22 that includes a lidar emitter and a lidar receiver. The lidar unit 62 can emit non-visible light waves for purposes of object detection. The lidar unit 62 operates to obtain spatial or other physical information regarding one or more objects within the field of view of the lidar unit 62 through emitting light waves and receiving the reflected light waves. In many embodiments, the lidar unit 62 emits a plurality of light pulses (e.g., laser light pulses) and receives the reflected light pulses using a lidar receiver. The lidar unit 62 may be mounted (or installed) on the front of the vehicle 12. In such an embodiment, the lidar unit 62 can face an area in front of the vehicle 12 such that the field of view of the lidar unit 62 includes this area. The lidar unit 62 can be positioned in the middle of the front bumper of the vehicle 12, to the side of the front bumper of the vehicle 12, on the sides of the vehicle 12, on the rear of the vehicle 12 (e.g., a rear bumper), etc. And, although only a single lidar unit 62 is depicted in the illustrated embodiment, the vehicle 12 can include one or more lidar units. Moreover, the lidar data captured by the lidar unit 62 can be represented in a pixel array (or other similar visual representation). The lidar unit 62 can capture static lidar images and/or lidar image or video streams.

Radar unit 64 is an electronic vehicle device of the vehicle electronics 22 that uses radio waves to obtain spatial or other physical information regarding one or more objects within the field of view of the radar 64. The radar 64 includes a transmitter that transmits electromagnetic radio waves via use of a transmitting antenna and can include various electronic circuitry that enables the generation and modulation of an electromagnetic carrier signal. In other embodiments, the radar 64 can transmit electromagnetic waves within another frequency domain, such as the microwave domain. The radar 64 can include a separate receiving antenna, or the radar 64 can include a single antenna for both reception and transmission of radio signals. And, in other embodiments, the radar 64 can include a plurality of transmitting antennas, a plurality of receiving antennas, or a combination thereof so as to implement multiple input multiple output (MIMO), single input multiple output (SIMO), or multiple input single output (MISO) techniques. Although a single radar 64 is shown, the vehicle 12 can include one or more radars that can be mounted at the same or different locations of the vehicle 12.

Vehicle camera(s) 66 are mounted on vehicle 12 and may include any suitable system known or used in the industry. According to a non-limiting example, vehicle 12 includes a collection of CMOS cameras or image sensors 66 located around the vehicle, including a number of forward-facing CMOS cameras that provide digital images that can be subsequently stitched together to yield a 2D or 3D representation of the road and environment in front and/or to the side of the vehicle. The vehicle camera 66 may provide vehicle video data to one or more components of the vehicle electronics 22, including to the wireless communications device 30 and/or the AV control unit 24. Depending on the particular application, the vehicle camera 66 may be: a still camera, a video camera, and/or some other type of image generating device; a BW and/or a color camera; a front-, rear- side- and/or 360°-facing camera; part of a mono and/or stereo system; an analog and/or digital camera; a short-, mid- and/or long-range camera; and a wide and/or narrow field of view (FOV) (aperture angle) camera, to cite a few possibilities. In one example, the vehicle camera 66 outputs raw vehicle video data (i.e., with no or little pre-processing), whereas in other examples the vehicle camera 66 includes image processing resources and performs pre-processing on the captured images before outputting them as vehicle video data.

The movement sensors 68 can be used to obtain movement or inertial information concerning the vehicle, such as vehicle speed, acceleration, yaw (and yaw rate), pitch, roll, and various other attributes of the vehicle concerning its movement as measured locally through use of onboard vehicle sensors. The movement sensors 68 can be mounted on the vehicle in a variety of locations, such as within an interior vehicle cabin, on a front or back bumper of the vehicle, and/or on the hood of the vehicle 12. The movement sensors 68 can be coupled to various other electronic vehicle devices directly or via the communications bus 40. Movement sensor data can be obtained and sent to the other electronic vehicle devices, including AV control unit 24, the BCM 44, and/or the wireless communications device 30.

In one embodiment, the movement sensors 68 can include wheel speed sensors, which can be installed into the vehicle as an onboard vehicle sensor. The wheel speed sensors are each coupled to a wheel of the vehicle 12 and can determine a rotational speed of the respective wheel. The rotational speeds from various wheel speed sensors can then be used to obtain a linear or transverse vehicle speed. Additionally, in some embodiments, the wheel speed sensors can be used to determine acceleration of the vehicle. In some embodiments, wheel speed sensors can be referred to as vehicle speed sensors (VSS) and can be a part of an anti-lock braking (ABS) system of the vehicle 12 and/or an electronic stability control program. The electronic stability control program can be embodied in a computer program or application that can be stored on a non-transitory, computer-readable memory (such as that which is included in memory of the AV control unit 24 or memory 38 of the wireless communications device 30). The electronic stability control program can be executed using a processor of AV control unit 24 (or the processor 36 of the wireless communications device 30) and can use various sensor readings or data from a variety of vehicle sensors including onboard vehicle sensor data from sensors 62-68.

Additionally or alternatively, the movement sensors 68 can include one or more inertial sensors, which can be installed into the vehicle as an onboard vehicle sensor. The inertial sensor(s) can be used to obtain sensor information concerning the acceleration and the direction of the acceleration of the vehicle. The inertial sensors can be microelectromechanical systems (MEMS) sensor or accelerometer that obtains inertial information. The inertial sensors can be used to detect collisions based on a detection of a relatively high deceleration. When a collision is detected, information from the inertial sensors used to detect the collision, as well as other information obtained by the inertial sensors, can be sent to the AV controller 24, the wireless communication device 30, the BCM 44, or other portion of the vehicle electronics 22. Additionally, the inertial sensor can be used to detect a high level of acceleration or braking. In one embodiment, the vehicle 12 can include a plurality of inertial sensors located throughout the vehicle. And, in some embodiments, each of the inertial sensors can be a multi-axis accelerometer that can measure acceleration or inertial force along a plurality of axes. The plurality of axes may each be orthogonal or perpendicular to one another and, additionally, one of the axes may run in the direction from the front to the back of the vehicle 12. Other embodiments may employ single-axis accelerometers or a combination of single-and multi- axis accelerometers. Other types of sensors can be used, including other accelerometers, gyroscope sensors, and/or other inertial sensors that are known or that may become known in the art.

The movement sensors 68 can include one or more yaw rate sensors, which can be installed into the vehicle as an onboard vehicle sensor. The yaw rate sensor(s) can obtain vehicle angular velocity information with respect to a vertical axis of the vehicle. The yaw rate sensors can include gyroscopic mechanisms that can determine the yaw rate and/or the slip angle. Various types of yaw rate sensors can be used, including micromechanical yaw rate sensors and piezoelectric yaw rate sensors.

The movement sensors 68 can also include a steering wheel angle sensor, which can be installed into the vehicle as an onboard vehicle sensor. The steering wheel angle sensor is coupled to a steering wheel of vehicle 12 or a component of the steering wheel, including any of those that are a part of the steering column. The steering wheel angle sensor can detect the angle that a steering wheel is rotated, which can correspond to the angle of one or more vehicle wheels with respect to a longitudinal axis that runs from the back to the front of the vehicle 12. Sensor data and/or readings from the steering wheel angle sensor can be used in the electronic stability control program that can be executed on a processor of AV control unit 24 or the processor 36 of the wireless communications device 30.

The vehicle electronics 22 also includes a number of vehicle-user interfaces that provide vehicle occupants with a means of providing and/or receiving information, including the visual display 50, pushbutton(s) 52, microphone(s) 54, and an audio system (not shown). As used herein, the term “vehicle-user interface” broadly includes any suitable form of electronic device, including both hardware and software components, which is located on the vehicle and enables a vehicle user to communicate with or through a component of the vehicle. An audio system can be included that provides audio output to a vehicle occupant and can be a dedicated, stand-alone system or part of the primary vehicle audio system. The pushbutton(s) 52 allow vehicle user input into the wireless communications device 30 to provide other data, response, or control input. The microphone(s) 54 (only one shown) provide audio input (an example of vehicle user input) to the vehicle electronics 22 to enable the driver or other occupant to provide voice commands and/or carry out hands-free calling via the wireless carrier system 70. For this purpose, it can be connected to an on-board automated voice processing unit utilizing human-machine interface (HMI) technology known in the art. Visual display or touch screen 50 can be a graphics display and can be used to provide a multitude of input and output functions. Display 50 can be a touchscreen on the instrument panel, a heads-up display reflected off of the windshield, or a projector that can project graphics for viewing by a vehicle occupant. In one embodiment, the display 50 is a touchscreen display that can display a graphical user interface (GUI) and that is capable of receiving vehicle user input, which can be used as part of a behavior query, which is discussed more below. Various other human-machine interfaces for providing vehicle user input from a human to the vehicle 12 or system 10 can be used, as the interfaces of FIG. 1 are only an example of one particular implementation. In one embodiment, the vehicle-user interfaces can be used to receive vehicle user input that is used to define a behavior query that is used as input in executing the composite behavior policy.

Wireless carrier system 70 may be any suitable cellular telephone system or long-range wireless system. The wireless carrier system 70 is shown as including a cellular tower 72; however, the carrier system 70 may include one or more of the following components (e.g., depending on the cellular technology): cellular towers, base transceiver stations, mobile switching centers, base station controllers, evolved nodes (e.g., eNodeBs), mobility management entities (MMEs), serving and PGN gateways, etc., as well as any other networking components required to connect wireless carrier system 70 with the land network 76 or to connect the wireless carrier system with user equipment (UEs, e.g., which can include telematics equipment in vehicle 12). The wireless carrier system 70 can implement any suitable communications technology, including GSM/GPRS technology, CDMA or CDMA2000 technology, LTE technology, etc. In general, wireless carrier systems 70, their components, the arrangement of their components, the interaction between the components, etc. is generally known in the art.

Land network 76 may be a conventional land-based telecommunications network that is connected to one or more landline telephones and connects wireless carrier system 70 to remote servers 78. For example, land network 76 may include a public switched telephone network (PSTN) such as that used to provide hardwired telephony, packet-switched data communications, and the Internet infrastructure. One or more segments of land network 76 could be implemented through the use of a standard wired network, a fiber or other optical network, a cable network, power lines, other wireless networks such as wireless local area networks (WLANs), networks providing broadband wireless access (BWA), or any combination thereof. The land network 76 and/or the wireless carrier system 70 can be used to communicatively couple the remote servers 78 with the vehicles 12, 14.

The remote servers 78 can be used for one or more purposes, such as for providing backend autonomous services for one or more vehicles. In one embodiment, the remote servers 78 can be any of a number of computers accessible via a private or public network such as the Internet. The remote servers 78 can include a processor and memory, and can be used to provide various information to the vehicles 12, 14, as well as to the HWD 90. In one embodiment, the remote servers 78 can be used to improve one or more behavior policies. For example, in some embodiments, the constituent behavior policies can use constituent behavior policy parameters for mapping an observed vehicle state to a vehicle action (or distribution of vehicle actions). These constituent behavior policy parameters can be used as a part of a neural network that performs this mapping of the observed vehicle state to a vehicle action (or distribution of vehicle actions). The constituent behavior policy parameters can be learned (or otherwise improved) through various techniques, which can be performed using various observed vehicle state information and/or feedback (e.g., reward, value) information from a fleet of vehicles, including vehicle 12 and vehicle 14, for example. Certain constituent behavior policy information can be sent from the remote servers 78 to the vehicle 12, such as in response to a request from the vehicle or in response to the behavior query. For example, the vehicle user can use the HWD 90 to provide vehicle user input that is used to define a behavior query. The behavior query can then be sent from the HWD 90 to the remote servers 78 and the constituent behavior policies can be identified based on the behavior query. Information pertaining to these constituent behavior policies can then be sent to the vehicle, which then can use this constituent behavior policy information in carrying out the composite behavior policy execution process. Also, in some embodiments, the remote servers 78 (or other system remotely located from the vehicle) can carry out the composite behavior policy execution process using a vehicle environment simulator. The vehicle environment simulator can provide a simulated environment for testing and/or improving (e.g., through machine learning) the composite behavior policy execution process. The behavior queries for these simulated iterations of the composite behavior policy execution process can be automatically-generated.

The handheld wireless device (HWD) 90 is a personal device and may include:

hardware, software, and/or firmware enabling cellular telecommunications and short-range wireless communications (SRWC) as well as mobile device applications, such as a vehicle user application 92. The hardware of the HWD 90 may comprise: a processor and memory for storing the software, firmware, etc. The HWD processor and memory may enable various software applications, which may be preinstalled or installed by the user (or manufacturer). In one embodiment, the HWD 90 includes a vehicle user application 92 that enables a vehicle user to communicate with the vehicle 12 (e.g., such as inputting route or trip parameters, specifying vehicle preferences, and/or controlling various aspects or functions of the vehicle, some of which are listed above). In one embodiment, the vehicle user application 92 can be used to receive vehicle user input from a vehicle user, which can include specifying or indicating one or more constituent behavior policies to use as input for generating and/or executing the composite behavior policy. This feature may be particularly suitable in the context of a ride sharing application, where the user is arranging for an autonomous vehicle to use for a certain amount of time.

In one particular embodiment, the HWD 90 can be a personal cellular device that includes a cellular chipset and/or cellular connectivity capabilities, as well as SRWC capabilities (e.g., Wi-Fi™, Bluetooth™). Using a cellular chipset, for example, the HWD 90 can connect with various remote devices, including remote servers 78 via the wireless carrier system 70 and/or the land network 76. As used herein, a personal device is a mobile device that is portable by a user and that is carried by the user, such as where the portability of the device is dependent on the user (e.g., a smartwatch or other wearable device, an implantable device, a smartphone, a tablet, a laptop, or other handheld device). In some embodiments, the HWD 90 can be a smartphone or tablet that includes an operating system, such as AndroidTM, iOS™, Microsoft Windows™ and/or other operating system.

The HWD 90 can also include a short range wireless communications (SRWC) circuit and/or chipset as well as one or more antennas, which allows it to carry out SRWC, such as any of the IEEE 802.11 protocols, Wi-Fi™, WiMAX™, ZigBee™ Wi-Fi Direct™, Bluetooth™, or near field communication (NFC). The SRWC circuit and/or chipset may allow the HWD 90 to connect to another SRWC device, such as a SRWC device of the vehicle 12, which can be a part of an infotainment unit and/or a part of the wireless communications device 30. Additionally, as mentioned above, the HWD 90 can include a cellular chipset thereby allowing the device to communicate via one or more cellular protocols, such as GSM/GPRS technology, CDMA or CDMA2000 technology, and LTE technology. The HWD 90 may communicate data over wireless carrier system 70 using the cellular chipset and an antenna.

The vehicle user application 92 is an application that enables the user to interact with the vehicle and/or backend vehicle systems, such as those provided by the remote servers 78. In one embodiment, the vehicle user application 92 enables a vehicle user to make a vehicle reservation, such as to reserve a particular vehicle with a car rental or ride sharing entity. The vehicle user application 92 can also enable the vehicle user to specify preferences of the vehicle, such as selecting one or more constituent behavior policies or preferences for the vehicle to use when carrying out autonomous vehicle (AV) functionality. In one embodiment, vehicle user input is received at the vehicle user application 92 and this input is then used as a part of a behavior query that specifies constituent behavior policy selections to implement when carrying out autonomous vehicle functionality. The behavior query (or other input or information) can be sent from the HWD 90 to the vehicle 12, to the remote server 78, and/or to both.

Any one or more of the processors discussed herein can be any type of device capable of processing electronic instructions including microprocessors, microcontrollers, host processors, controllers, vehicle communication processors, General Processing Unit (GPU), accelerators, Field Programmable Gated Arrays (FPGA), and Application Specific Integrated Circuits (ASICs), to cite a few possibilities. The processor can execute various types of electronic instructions, such as software and/or firmware programs stored in memory, which enable the module to carry out various functionality. Any one or more of the memory discussed herein can be a non-transitory computer-readable medium; these include different types of random-access memory (RAM), including various types of dynamic RAM (DRAM) and static RAM (SRAM)), read-only memory (ROM), solid-state drives (SSDs) (including other solid-state storage such as solid state hybrid drives (SSHDs)), hard disk drives (HDDs), magnetic or optical disc drives, or other suitable computer medium that electronically stores information. Moreover, although certain electronic vehicle devices may be described as including a processor and/or memory, the processor and/or memory of such electronic vehicle devices may be shared with other electronic vehicle devices and/or housed in (or a part of) other electronic vehicle devices of the vehicle electronics—for example, any of these processors or memory can be a dedicated processor or memory used only for module or can be shared with other vehicle systems, modules, devices, components, etc.

As discussed above, the composite behavior policy is a set of customizable driving profiles or styles that is based on the constituent behavior policies selected by the user. Each constituent behavior policy can be used to map an observed vehicle state to a vehicle action (or distribution of vehicle actions) that is to be carried out. A given behavior policy can include different behavior policy parameters that are used as a part of mapping an observed vehicle state to a vehicle action (or distribution of vehicle actions). Each behavior policy (including the behavior policy parameters) can be trained so as to map the observed vehicle state to a vehicle action (or distribution of vehicle actions) so that, when executed, the autonomous vehicle (AV) functionality emulates a particular style and/or character of driving, such as fast driving, aggressive driving, conservative driving, slow driving, passive driving, etc. For example, a first exemplary behavior policy is a passive policy such that, when autonomous vehicle functionality is executed according to this passive policy, autonomous vehicle actions that are characterized as more passive than average (e.g., vehicle actions that result in allowing another vehicle to merge into the vehicle's current lane) are selected. Some non-limiting examples of how to create, build, update, modify and/or utilize such behavior policies can be found in U.S. Ser. No. 16/048157 filed Jul. 27, 2018 and Ser. No. 16/048144 filed Jul. 27, 2018, which are owned by the present assignee. The composite behavior policy is a customized driving policy that is carried out by a composite behavior policy execution process, which includes mixing, blending, or otherwise combining two or more constituent behavior policies according to the behavior query so that the observed vehicle state is mapped to a vehicle action (or a set or distribution of vehicle actions) that, when executed, reflects the style of any one or more of the constituent behavior policies.

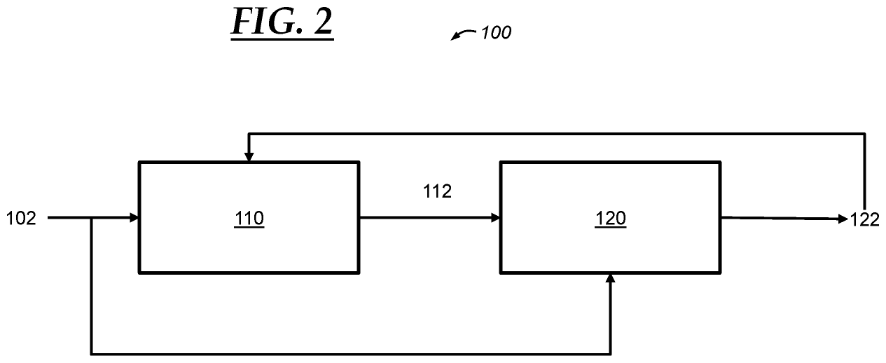

According to at least one embodiment, the behavior policy can be carried out using an actor-critic deep reinforcement learning (DRL) technique, which includes a policy layer and a value (or reward) layer (referred to herein as “value layer”). As shown in FIG. 2, a policy layer 110 and a value layer 120 are each comprised of a neural network that maps the respective inputs (i.e., the observed vehicle state 102 for the policy layer 110, and the observed vehicle state 102 and the selected vehicle action 112 for the value layer 120) to outputs (i.e., distribution of vehicle actions for the policy layer (one of which is selected as the vehicle action 112), a value (or distribution of values) 122 for the value layer 120) using behavior policy parameters. The behavior policy parameters of the policy layer 110 are referred to as policy layer parameters (denoted as 0) and the behavior policy parameters for the value layer 120 are referred to as value layer parameters (denoted as w). The policy layer 110 determines a distribution of vehicle actions based on the observed vehicle state, which depends on the policy layer parameters. At least in one embodiment, the policy layer parameter are weights of nodes within the neural network that constitutes the policy layer 110. For example, the policy layer 110 can map the observed vehicle state to a distribution of vehicle actions and then a vehicle action 112 can be selected (e.g., sampled) from this distribution of vehicle actions and fed or inputted to the value layer 120. The distribution of vehicle actions includes a plurality of vehicle actions that are distributed over a set of probabilities—for example, the distribution of vehicle actions can be a Gaussian or normal distribution such that the sum of probabilities of the distribution of vehicle actions equals one. The selected vehicle action 112 is chosen in accordance with the probabilities of the vehicle actions within the distribution of vehicle actions.

The value layer 120 determines a distribution of values (one of which is sampled as value 122) based on the observed vehicle state 102 and the selected vehicle action 112 that is carried out by the vehicle. The value layer 120 functions to critique the policy layer 110 so that the policy layer parameters (i.e., weights of one of the neural network(s) of the policy layer 110) can be adjusted based on the value 122 that is output by the value layer 120. In at least one embodiment, since the value layer 120 takes the selected vehicle action 112 (or output of the policy layer) as input, the value layer parameters are also adjusted in response to (or as a result of) adjusting the policy layer parameters. A value 122 to provide as feedback to the policy layer can be sampled from a distribution of values produced by the value layer 120.

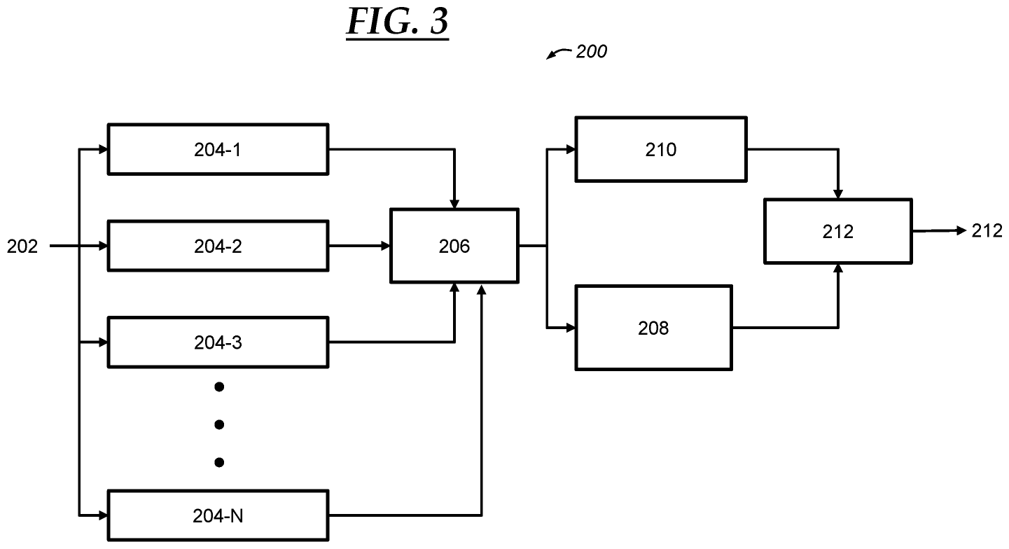

With reference to FIG. 3, there is shown an embodiment of a composite behavior policy execution system 200 that is used to carry out a composite behavior policy execution process. The composite behavior policy execution process includes blending, merging, or otherwise combining the constituent behavior policies, which can be identified based on the behavior query. The constituent behavior policies can use an actor-critic DRL model as illustrated in FIG. 2 above, for example. When executed, the composite behavior policy combines these constituent behavior policies, which can include using one or more of the behavior policy parameters of the policy layer 110 and/or the value layer 120.

According to one embodiment, the composite behavior policy execution system 200 can be implemented using one or more electronic vehicle devices of the vehicle 12, such as the AV controller 24. In general, the composite behavior policy execution system 200 includes a plurality of encoder modules 204-1 to 204-N, a constrained embedding module 206, a composed embedding module 208, a composed layer module 210, and an integrator module 212. The composite behavior policy execution system 200 may carry out a composite behavior policy execution process, which selects one or more vehicle actions, such as autonomous driving maneuvers, based on an observed vehicle state that is determined from various onboard vehicle sensors.

As mentioned above, a behavior policy can be used by an electronic vehicle device (e.g., the AV controller 24 of the vehicle 12) to carry out autonomous functionality. The behavior policies can be made up of one or more neural networks, and can be trained using various machine learning techniques, including deep reinforcement learning (DRL). In one embodiment, the behavior policies follow an actor-critic model that includes a policy layer that is carried out by the actor and a value layer (including a behavior policy value function) that is carried out by the critic. The policy layer utilizes policy parameters or weights θ that dictate a distribution of actions based on the observed vehicle state, and the value layer can utilize value parameters or weights w that dictate a reward in response to carrying out a particular action based on the observed vehicle state. These behavior policy parameters or weights, which include the policy parameters 0 and the value parameters w and are part of their respective neural networks, can be improved or optimized using machine learning techniques with various observed vehicle states from a plurality of vehicles as input, and such learning can be carried out at the remote servers 78 and/or the vehicles 12, 14. In one embodiment, based on an observed vehicle state, the policy layer of the behavior policy can define an vehicle action (or distribution of vehicle actions), and the value layer can define the value or reward in carrying out a particular vehicle action provided the observed vehicle state according to a behavior policy value function, which can be implemented as a neural network. Using the composite behavior policy execution system 200, a composite behavior policy can be developed or learned through combining two or more behavior policies, which includes combining (e.g., blending, margining, composing) parts from each of the behavior policies, as well as combining the behavior policy value functions from each of the behavior policies.

In one embodiment, such as when an actor-critic model is followed for the behavior policies (or at least the composite behavior policy), the composite behavior policy execution system 200 includes two processes: (1) generating the policy layer (or policy functionality), which is used by the actor; and (2) generating the value layer (or the behavior policy value function), which is used by the critic. In one embodiment, the AV controller 24 (or other vehicle electronics 22) is the actor in the actor-critic model when the composite behavior policy is implemented by the vehicle. Also, in one embodiment, the AV controller 24 (or other vehicle electronics 22) can also carry out the critic role so that the policy layer is provided feedback for carrying out a particular action in response to the observed vehicle state. The actor role can be carried out by an actor module, and the critic role can be carried out by a critic module. In one embodiment, the actor module and the critic module is carried out by the AV controller 24. However, in other embodiments, the actor module and/or the critic module is carried out by other portions of the vehicle electronics 22 or by the remote servers 78.

The following description of the modules 204-212 (i.e., the plurality of encoder modules 204-1 to 204-N, the constrained embedding module 206, the composed embedding module 208, the composed layer module 210, and the integrator module 212) is discussed with respect to the policy layer, which results in obtaining a distribution of vehicle actions, one of which is then selected (e.g., sampled based on the probability distribution) to be carried out by the vehicle. In at least one embodiment, such as when an actor-critic DRL model is used for the composite behavior policy execution system 200, the modules 204-212 can be used to combine value layers from the constituent behavior policies to obtain a distribution of values (or rewards), one of which is sampled so as to obtain a value or reward that is used as feedback for the policy layer.

The plurality of encoder modules 204-1 to 204-N take an observed vehicle state as an input, and generate or extract low-dimensional embeddings based on the composite behavior policy and/or the plurality of behavior policies that are to be combined. Any suitable number Nof encoder modules can be used and, in at least some embodiments, each encoder module 204-1 to 204-N is associated with a single constituent behavior policy. In one embodiment, the number N of encoder modules corresponds to the number of constituent behavior policies selected as a part of the behavior query, where each encoder module 204-1 to 204-N is associated with a single constituent behavior policy. Various techniques can be used for generating the low-dimensional embeddings, such as those used for encoding as a part of an autoencoder, which can be a deep autoencoder. An example of some techniques that can be used are described in Deep Auto-Encoder Neural Networks in Reinforcement Learning, Sascha Lange and Martin Riedmiller. For example, a first low-dimensional embedding can be represented as E₁(O; θ₁), where P is the observed vehicle state, and theθ₁ represents the parameters (e.g., weights) used for mapping the observed vehicle state to a low-dimensional embedding for the first encoder module 204-1. Likewise, a second low-dimensional embedding can be represented as E₂(O; θ₂), where O is the observed vehicle state, and the θ₂ represents the parameters (e.g., weights) used for mapping the observed vehicle state to a low-dimensional embedding for the second encoder module 204-2. In at least some embodiments, the encoder modules 204-1 to 204-N are used to map the observed vehicle state O (indicated at 202) to a feature space or latent vector Z, which is represented by the low-dimensional embeddings. The feature space or latent vector Z (referred to herein as feature space Z) can be constructed using various techniques, including encoding as a part of a deep autoencoding process or technique. Thus, in one embodiment, the low-dimensional embeddings E₁(O; θ₁) to E_{N}(O; θ_{N}) are each associated with a latent vector Z₁ to Z_{N} that is the output of the encoder modules 204-1 to 204-N.

At least in some embodiments, the parameters θ₁ to θ_{N} can be improved by using gradient descent techniques, which can include using backpropagation along with a loss function. Also, in some embodiments, the low-dimensional embeddings can be generated in a way to represent the observed vehicle state O (which is, in many embodiments, a high-dimensional vector) in a way that facilitates transferrable and composable (or combinable) behavior policy learning for autonomous vehicle functionality and logic. That is, since the low-dimensional embeddings are combined at the constrained embedding module 206 based on the produced or outputted feature spaces Z₁ to Z_{N}, the encoder modules 204-1 to 204-N can be configured so as to produce feature spaces Z₁ to Z_{N} that are composable or otherwise combinable. In this sense, the feature spaces Z₁ to Z_{N} can be produced in a way that enables them to be regularized or normalized so that they can be combined. Once the low-dimensional embeddings are generated or otherwise obtained, then these low-dimensional embeddings are processed by the constrained embedding module 206.

The constrained embedding module 206 normalizes the low-dimensional embeddings so that they can be combined, which can include constraining the low-dimensional embeddings (or the output of the encoder modules 204-1 to 204-N) using an objective or loss function to produce a constrained embedding space Zc. Examples of techniques that can be used by the constrained embedding module 206 can be found in Learning an Embedding Space for Transferable Robot Skills, Karol Hausman, et al. (ICLR 2018). The constrained embedding space Zc is a result of combining one or more of the feature spaces Z₁ to Z_{N}. In one embodiment, the resulting constrained embedding space can be produced through using a loss function that, when applied to the one or more of the feature spaces Z₁ to Z_{N}, produces a constrained embedding space Z_{C} corresponding to portions of the one or more of the feature spaces Z₁ to Z_{N} that overlap or are in close proximity. The constrained embedding module 206 can be used to provide such a constrained embedding space Zc (which combines the outputs from each encoder module 204-1 to 204-N) that allows the low-dimensional embeddings to be combinable. As a result of the constrained embedding module 206, a trained encoding distribution for each low-dimensional embedding E₁ through E_{N} is obtained. A first trained encoding distribution is represented by p(E₁|O; θ₁), a second trained encoding distribution is represented by p(E₂|O; θ₂), etc. Each of these trained encoding distributions provide a distribution for an embedding (e.g., E₁ for the first trained encoding), which is a result of the observed vehicle state O and the behavior policy parameters θₙ (e.g., θ₁ for the first trained encoding distribution). These trained encoding distributions together correspond or make up constrained embeddings denoted as E_{C}. In many embodiments, this distribution is a stochastic probability distribution that is based on the observations O and behavior policy parameters (e.g., θ₁ for the first trained encoding distribution). For each of the trained encoding distributions, a vector (or value) can be sampled (referred to as a sampled embedding output) and used as input into the composed embedding module 208. As used herein, sampling or any of its other forms refers to selecting or obtaining an output (e.g., vector, value) according to a probability distribution.

Once the low-dimensional embeddings are constrained according to the loss function to obtain constrained embedding space Z_{C} and the trained encoding distributions p(Eₙ|O; θₙ), the composed embedding module 208 uses a combined embedding stochastic function p(E_{C}|E₁, E₂, . . . E_{N}|; θ_{C}) that produces a distribution representing constrained embeddings E_{C} through combining the outputs of the trained encoding distributions using a neural network with composed embedding parameters θ_{C}. In one embodiment, the inputs into this neural network are those sampled embedding outputs obtained as a result of sampling values, vectors, or other outputs from each of the trained encoding distributions. For example, the constrained embeddings E_{C} (which can represent a distribution) is used to select an embedding vector that can then be used as a part of a composed policy layer, which is produced using the composed layer module 210. In many embodiments, the distribution of the composite embedding Ec that is produced as a result of composed embedding module 208 can be generated based on or according to the behavior query. For example, when the behavior query includes inputs that specify a certain percentage (or other value) of the one or more constituent behavior policies (e.g., 75% fast, 25% conservative), the composed embedding parameters θ_{C} can be adjusted so that a resulting probability distribution is produced by the composed embedding module 208 that reflects the inputs of the behavior query.

The composed layer module 210 is used to produce a composite policy function π(a|E_{C}: θₚ)that can be used to output a distribution of vehicle actions using composed layer parameters θₚ. In one embodiment, the composed layer parameters θₚ can initially be selected based on behavior policy parameters of the constituent behavior policies and/or in accordance with the behavior query. Also, in at least some embodiments, the composed layer module 210 is a neural network (or other differentiable function) that is used to map the constrained embeddings E_{C} to a distribution of vehicle actions (denoted by a) through a composite policy function π.

The integrator module 212 is used to sample a vehicle action based on a sampled feature vector from the feature space of the constrained embeddings E_{C}. In one embodiment, a feature vector is sampled from the combined embedding stochastic function, and then the sampled feature vector is used by the composite policy function π(a|E_{C}; θₚ) to obtain a distribution of vehicle actions. In some embodiments, an integral of the composite policy function π(a|E_{C}; θₚ) and the combined embedding stochastic function p(E_{C}|E₁, E₂, . . . E_{N}|; θ_{C}) can be taken by the following, where the integration is with respect to dE_{c} over the constrained embedding space:

π_{C}(a|s)=∫π(a|E_{C}; θₚ)p(E_{C}|E₁, E₂, . . . E_{N}|; θ_{C})dE_{C}

Once a distribution of vehicle actions are obtained, a vehicle action can be sampled from this distribution. The sampled vehicle action 212 can then be carried out. In general, the composite behavior policy π_{C}(a|s), which maps a vehicle state s (or observed vehicle state O) to a vehicle action a can be represented as follows:

π_{C}(a|s)=π(a|E_{C}; θₚ)p(E_{C}|E₁/E₂, . . . E_{N}|; θ_{C})p(E₁|O; θ₁) . . .p(E_{N}|O; θ_{N})

where p(Eₙ|O; θₙ) represents the trained encoding distribution for the n-th constituent behavior policy, p(E_{C}|E₁, E₂, . . . E_{N}|; θ_{C}) represents the combined embedding stochastic function, and π(a|E_{C}; θₚ) represents the policy function, and as discussed above.

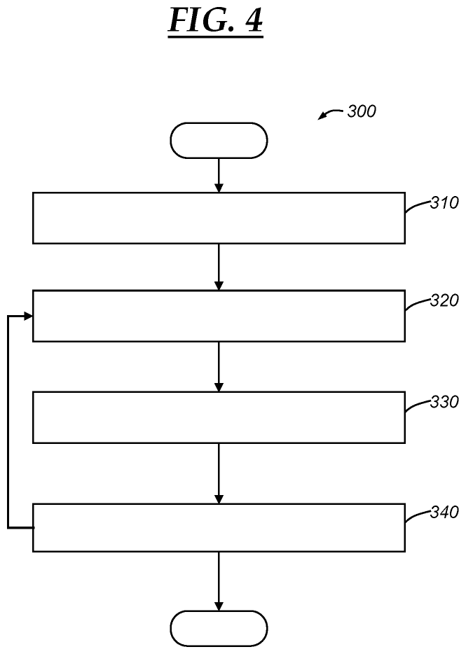

With reference to FIG. 4, there is shown a flow chart depicting an exemplary method 300 of generating a composite behavior policy for an autonomous vehicle. The method 300 can be carried out by any of, or any combination of, the components of system 10, including the following: the vehicle electronics 22, the remote server 78, the HWD 90, any combination thereof

In step 310, a behavior query is obtained, wherein the behavior query indicates a plurality of constituent behavior policies to be used with the composite behavior policy. The behavior query is used to specify the constituent behavior policies that will be used (or combined) to produce the composite behavior policy. As one example, the behavior query can simply identify a plurality of constituent behavior policies that are to be used in generating a composite behavior policy, or at least as a part of a composite behavior policy execution process. In another example, the behavior query can also include one or more composite behavior policy preferences in addition to the specified behavior policies. These composite behavior policy preferences can be used in defining certain characteristics of the to-be-generated composite behavior policy, such as a behavior policy weighting value that specifies how prominent certain attributes of a particular one of the plurality of constituent behavior policies is to be as a part of the composite behavior policy (e.g., 75% fast, 25% conservative).

The composite behavior query can be generated based on vehicle user input, or based on automatically-generated inputs. As used herein, vehicle user input is any input that is received into the system 10 from a vehicle user, such as input that is received from the vehicle-user interfaces 50-54, input received from HWD 90 via a vehicle user application 92, and information received from a user or operator located at the remote server. As used herein, automatically-generated inputs are those that are generated programmatically by an electronic computer or computing system without direct vehicle user input. For example, an application being executed on one of the remote servers 78 can periodically generate a behavior query by selecting a plurality of constituent behavior policies and/or associated composite behavior policy preferences.

In one embodiment, a touchscreen interface at the vehicle 12, such as a graphical user interface (GUI) provided on the display 50, can be used to obtain the vehicle user input. For example, a vehicle user can select one or more predefined (or pre-generated) behavior policies that are to be used as constituent behavior policy in generating and/or executing the composite behavior policy. As another example, a dial or a knob on the vehicle can be used to receive vehicle user input, gesture input can be received at the vehicle using the vehicle camera 66 (or other camera) in conjunction with image processing/object recognition techniques, and/or speech or audio input can be received at the microphone 54 and processed using speech processing/recognition techniques. In another embodiment, the vehicle camera 66 can be installed in the vehicle so as to face an area in which a vehicle user is located while seated in the vehicle. Images can be captured and then processed to determine facial expressions (or other expressions) of the vehicle user. These facial expressions can then be used to classify or otherwise determine emotions of the vehicle user, such as whether the vehicle user is apprehensive or worried. Then, based on the classified or determined emotions, the behavior query can be adapted or determined. For example, the vehicle electronics 22 may determine that the vehicle user is showing signs of being nervous or stressed; thus, in response, a conservative behavior policy and a slow behavior policy can be selected as constituent behavior policies for the behavior query.

In one embodiment, the vehicle user can use the vehicle user application 92 of the HWD 90 to provide vehicle user input that is used in generating the composite behavior query. The vehicle user application 92 can present a list of a plurality of predefined (or pre-generated) behavior policies that are selectable by the vehicle user. The vehicle user can then select two or more of the behavior policies, which then form a part of the behavior query. The behavior query is then communicated to the remote server 78, the vehicle electronics 22, and/or another device/system that is to carry out the composite behavior policy generation process. In another embodiment, a vehicle user can use a web application to specify vehicle user inputs that are used in generating the behavior query. The method 300 then continues to step 320.

In step 320, an observed vehicle state is obtained. In many embodiments, the observed vehicle state is a state of the vehicle as observed or determined based on onboard vehicle sensor data from one or more onboard vehicle sensors, such as sensors 62-68. Additionally, the observed vehicle state can be determined based on external vehicle state information, such as external vehicle sensor data from nearby vehicle 14, which can be communicated from the nearby vehicle 14 to the vehicle 12 via V2V communications, for example. Other information can be used as a part of the observed vehicle state as well, such as road geometry information, other road information, traffic signal information, traffic information (e.g., an amount of traffic on one or more nearby road segments), weather information, edge or fog layer sensor data or information, etc. The method 300 then continues to step 330.

In step 330, a vehicle action is selected using a composite behavior policy execution process. An example of a composite behavior policy execution process is discussed above with respect to FIG. 3. In such an embodiment, the composite behavior policy execution process is used to determine a distribution of vehicle actions based on the constituent behavior policies (output of the policy layer). Once the distribution of vehicle actions, a single vehicle action is sampled or otherwise selected. The composite behavior policy execution process can be carried out by the AV controller 24, at least in some embodiments.

In other embodiments, the composite behavior policy execution process can include determining a vehicle action (or distribution of vehicle actions) from each of the constituent behavior policies and, then, determining a composite vehicle action based on the plurality of vehicle actions (or distribution of vehicle actions). For example, a first behavior policy may result in a first vehicle action of braking at 10% braking power and a second behavior policy may result in a second vehicle action of braking at 20% braking power. A combined vehicle action can then be determined to be braking at 15% power, which is the average of the braking power of the first and second vehicle actions. In another embodiment, the composite behavior policy execution process can select one of the first vehicle action or the second vehicle action according to a composite behavior policy preferences (e.g., 25% aggressive, 75% fast). In yet another embodiment, each constituent behavior policy can be used to produce a distribution of vehicle actions for the observed vehicle state O. These distributions can be merged together or otherwise combined to produce a composite distribution of vehicle actions and, then, a single vehicle action can be sampled from this composite distribution of vehicle actions. Various other techniques for combining the constituent behavior policies and/or selecting a vehicle action based on these constituent behavior policies can be used. The method 300 then continues to step 340.

In step 340, the selected vehicle action is carried out. The selected vehicle action can be carried out by the AV controller 24 and/or other parts of the vehicle electronics 22. In one embodiment, the vehicle action can specify a specific vehicle action that is to be carried out by a particular component, such as an electromechanical component, which can be, for example, a braking module, a throttle, a steering component, etc. In other embodiments, the vehicle action can specify a trajectory that is to be taken by the vehicle and, based on this planned trajectory, one or more vehicle components can be controlled. Once the vehicle action is carried out, the method 300 ends, or loops back to step 320 for continued execution.

As mentioned above, in at least some embodiments, a value layer can be used to critique the policy layer so as to improve and/or optimize parameters used by the policy layer. Thus, the method 300 can further include determining a value based on the observed vehicle state and the selected vehicle action. In some embodiments, the value layer can determine a distribution of values based on the observed vehicle state and the selected vehicle action, and then a value can be sampled (or otherwise selected) based on this distribution of values. Various feedback techniques can be used to improve any one or more components of the neural networks used as a part of the composite behavior policy, including those of the constituent behavior policies and those used in the composite behavior policy execution process (e.g., those of modules 204 through 210 that use one or more neural networks).

It is to be understood that the foregoing description is not a definition of the invention, but is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. For example, the specific combination and order of steps is just one possibility, as the present method may include a combination of steps that has fewer, greater or different steps than that shown here. All such other embodiments, changes, and modifications are intended to come within the scope of the appended claims.

As used in this specification and claims, the terms “for example,” “e.g.,” “for instance,” “such as,” and “like,” and the verbs “comprising,” “having,” “including,” and their other verb forms, when used in conjunction with a listing of one or more components or other items, are each to be construed as open-ended, meaning that that the listing is not to be considered as excluding other, additional components or items. Other terms are to be construed using their broadest reasonable meaning unless they are used in a context that requires a different interpretation. In addition, the term “and/or” is to be construed as an inclusive or. As an example, the phrase “A, B, and/or C” includes: “A”; “B”; “C”; “A and B”; “A and C”; “B and C”; and “A, B, and C.”

1. A method of determining a vehicle action to be carried out by a vehicle based on a composite behavior policy, the method comprising the steps of:
obtaining a behavior query that indicates a plurality of constituent behavior policies to be used to execute the composite behavior policy, wherein each of the constituent behavior policies maps a vehicle state to one or more vehicle actions;
determining an observed vehicle state based on onboard vehicle sensor data, wherein the onboard vehicle sensor data is obtained from one or more onboard vehicle sensors of the vehicle;
selecting a vehicle action based on the composite behavior policy; and
carrying out the selected vehicle action at the vehicle.

2. The method of claim 1, wherein the selecting step includes carrying out a composite behavior policy execution process that blends, merges, or otherwise combines each of the plurality of constituent behavior policies so that, when the composite behavior policy is executed, autonomous vehicle (AV) behavior of the vehicle resembles a combined style or character of the constituent behavior policies.

3. The method of claim 2, wherein the composite behavior policy execution process and the carrying out step are carried out using an autonomous vehicle (AV) controller of the vehicle.

4. The method of claim 3, wherein the composite behavior policy execution process includes compressing or encoding the observed vehicle state into a low-dimension representation for each of the plurality of constituent behavior policies.

5. The method of claim 4, wherein the compressing or encoding step includes generating a low-dimensional embedding using a deep autoencoder for each of the plurality of constituent behavior policies.

6. The method of claim 5, wherein the composite behavior policy execution process includes regularizing or constraining each of the low-dimensional embeddings according to a loss function.

7. The method of claim 6, wherein a trained encoding distribution for each of the plurality of constituent behavior policies is obtained based on the regularizing or constraining step.

8. The method of claim 7, wherein each low-dimensional embedding is associated with a feature space Z₁ to Z_{N}, and wherein the composite behavior policy execution process includes determining a constrained embedding space based on the feature spaces Z₁ to Z_{N} of the low-dimensional embeddings.

9. The method of claim 8, wherein the composite behavior policy execution process includes determining a combined embedding stochastic function based on the low-dimensional embeddings.

10. The method of claim 9, wherein the composite behavior policy execution process includes determining a distribution of vehicle actions based on the combined embedding stochastic function and a composite policy function, and wherein the composite policy function is generated based on the constituent behavior policies.

11. The method of claim 10, wherein the selected vehicle action is sampled from the distribution of vehicle actions.

12. The method of claim 1, wherein the behavior query is generated based on vehicle user input received from a handheld wireless device.

13. The method of claim 1, wherein the behavior query is automatically generated without vehicle user input.

14. The method of claim 1, wherein each of the constituent behavior policies are defined by behavior policy parameters that are used in a first neural network that maps the observed vehicle state to a distribution of vehicle actions.

15. The method of claim 14, wherein the first neural network that maps the observed vehicle state to the distribution of vehicle actions is a part of a policy layer, and wherein the behavior policy parameters of each of the constituent behavior policies are used in a second neural network of a value layer that provides a feedback value based on the selected vehicle action and the observed vehicle state.

16. The method of claim 15, wherein the composite behavior policy is executed at the vehicle using a deep reinforcement learning (DRL) actor-critic model that includes a value layer and a policy layer, wherein the value layer of the composite behavior policy is generated based on the value layer of each of the plurality of constituent behavior policies, and wherein the policy layer of the composite behavior policy is generated based on the policy layer of each of the plurality of constituent behavior policies.

17. A method of determining a vehicle action to be carried out by a vehicle based on a composite behavior policy, the method comprising the steps of:
obtaining a behavior query that indicates a plurality of constituent behavior policies to be used to execute the composite behavior policy, wherein each of the constituent behavior policies are used to map a vehicle state to one or more vehicle actions;
determining an observed vehicle state based on onboard vehicle sensor data, wherein the onboard vehicle sensor data is obtained from one or more onboard vehicle sensors of the vehicle;
selecting a vehicle action based on the plurality of constituent behavior policies by carrying out a composite behavior policy execution process, wherein the composite behavior policy execution process includes:
determining a low-dimensional embedding for each of the constituent behavior policies based on the observed vehicle state;
determining a trained encoding distribution for each of the plurality of constituent behavior policies based on the low-dimensional embeddings;
combining the trained encoding distributions according to the behavior query so as to obtain a distribution of vehicle actions; and
sampling a vehicle action from the distribution of vehicle actions to obtain a selected vehicle action; and
carrying out the selected vehicle action at the vehicle.

18. The method of claim 17, wherein the composite behavior policy execution process is carried out using composite behavior policy parameters, and wherein the composite behavior policy parameters are improved or learned based on carrying out a plurality of iterations of the composite behavior policy execution process and receiving feedback from a value function as a result of or during each of the plurality of iterations of the composite behavior policy execution process.

19. The method of claim 18, wherein the value function is a part of a value layer, and wherein the composite behavior policy execution process includes executing a policy layer to select the vehicle action and the value layer to provide feedback as to the advantage of the selected vehicle action in view of the observed vehicle state.

20. The method of claim 19, wherein the policy layer and the value layer of the composite behavior policy execution process are carried by an autonomous vehicle (AV) controller of the vehicle.
